(19) United States
(12) Patent Application Publication
(10) Pub. No.: US 2018/0074765 A1
(43) Pub. Date: Mar. 15, 2018

(54) IMAGE FORMING APPARATUS, INFORMATION PROCESSING APPARATUS, AND NON-TRANSITORY COMPUTER READABLE MEDIUM

(71) Applicant: FUJI XEROX CO., LTD., Tokyo (JP)

(72) Inventors: Ryuichi ISHIZUKA, Kanagawa (JP); Chigusa NAKATA, Kanagawa (JP); Hiroshi HONDA, Kanagawa (JP); Eiji NISHI, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP)

(73) Assignee: FUJI XEROX CO., LTD., Tokyo (JP)

(21) Appl. No.: 15/455,373

(22) Filed: Mar. 10, 2017

(30) Foreign Application Priority Data
Sep. 14, 2016 (JP) 2016-179176

(51) Int. Cl. G06F 3/12; H04N 1/00

(52) U.S. Cl. CPC G06F 3/1273; H04N 1/00411; G06F 3/1211; G06F 3/1208

(57) ABSTRACT

Provided is an image forming apparatus including a printing unit that is capable of performing printing on a recording medium using information from terminal devices, a history information holding unit that holds printing history information including information of each of the terminal devices that have performed printing using the printing unit, and an identification unit that identifies status grasping target terminal devices by the information of the terminal devices, the information being included in the printing history information.

### CROSS-REFERENCE TO RELATED APPLICATIONS

This application is based on and claims priority under 35 USC 119 from Japanese Patent Application No. 2016-179176 filed Sep. 14, 2016.

### BACKGROUND

### Technical Field

The present invention relates to an image forming apparatus, an information processing apparatus, and a non-transitory computer readable medium.

### SUMMARY

According to an aspect of the invention, there is provided an image forming apparatus including:

a printing unit that is capable of performing printing on a recording medium using information from terminal devices;

a history information holding unit that holds printing history information including information of each of the terminal devices that have performed printing using the printing unit; and

an identification unit that identifies status grasping target terminal devices by the information of the terminal devices, the information being included in the printing history information.

### BRIEF DESCRIPTION OF THE DRAWINGS

Exemplary embodiments of the present invention will be described in detail based on the following figures, wherein:

FIG. 1 is a view illustrating an overall configuration of an office environment management system;

FIG. 2 is a view illustrating a hardware configuration of an image forming apparatus;

FIG. 3 is a view illustrating respective functional units implemented by a CPU or the like of the image forming apparatus;

FIG. 4 is a flow chart illustrating a flow of a process executed by the image forming apparatus;

FIG. 5 is a view illustrating an access list (printing history information) held by a history information holding unit; and

FIG. 6 is a view illustrating an information list.

### DETAILED DESCRIPTION

Hereinafter, an exemplary embodiment of the present invention will be described in detail with reference to accompanying drawings.

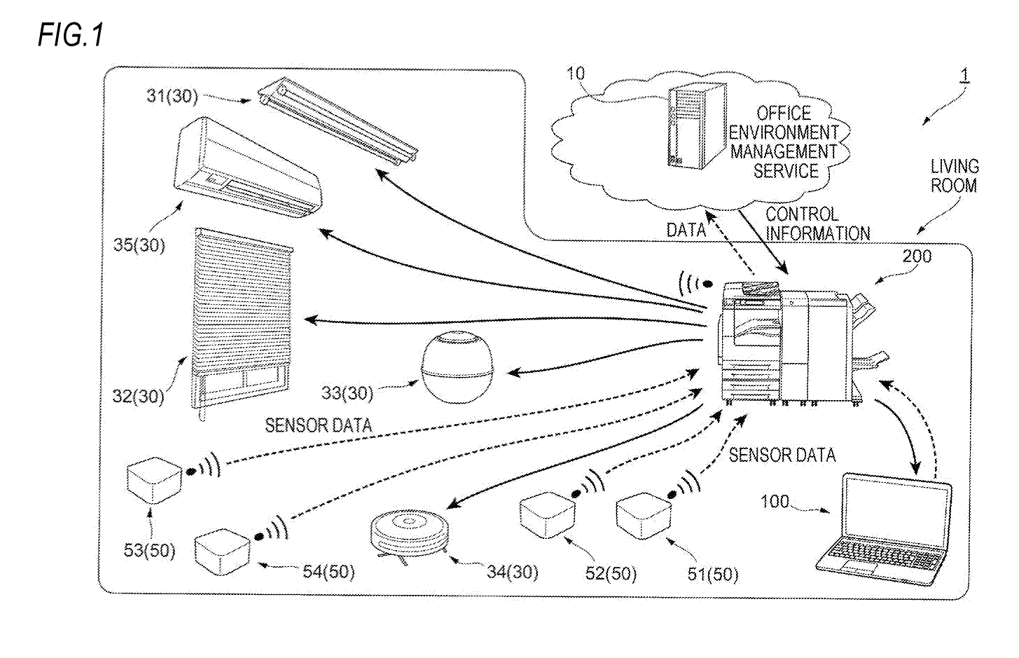

FIG. 1 is a view illustrating an overall configuration of an office environment management system 1.

The office environment management system 1 is equipped with a management server 10 provided on a cloud, as an example of an external device, and an image forming apparatus 200 connected to the management server 10 and serving as a gateway or an edge server.

The image forming apparatus 200 is provided in a living room (an office) where a user works. The image forming apparatus 200 has a FAX function or a scanner function as well as an image forming function.

In the office environment management system 1, plural devices 30 to be controlled (controlled devices 30) are provided. The controlled devices 30 are connected to the management server 10 via the image forming apparatus 200, and are controlled by the management server 10.

In the office environment management system 1 according to the present exemplary embodiment, plural sensors 50 are provided in the living room.

In the office environment management system 1, a computer device 100 as an example of a terminal device is provided in the living room. The computer device 100 is connected to the image forming apparatus 200 via a communication line such as a LAN, and exchanges information with the image forming apparatus 200. In FIG. 1, only one computer device 100 is illustrated, but plural computer devices 100 may be provided in the living room.

The controlled devices 30 communicate with the image forming apparatus 200, and receive control information from the image forming apparatus 200. In the present exemplary embodiment, as the controlled devices 30, a lighting device 31, a window shade device 32, a humidifier 33, a cleaning device 34, and an air conditioner 35 are provided.

The lighting device 31 includes a light source, and turns ON or OFF the light source according to control information from the management server 10.

The window shade device 32 includes a window shade and a driving mechanism that changes the state of the window shade, and changes the state of the window shade according to control information from the management server 10. Accordingly, the amount of external light that enters the inside of the living room is changed.

The humidifier 33 includes a mechanism configured to evaporate water, and performs humidification in the living room according to control information from the management server 10.

The cleaning device 34 includes a suction mechanism that sucks dust in the office, and collects dust in the living room while moving in the living room according to control information from the management server 10.

The air conditioner 35 includes a heating source or the like, and controls air conditioning in the office according to control information from the management server 10.

In the present exemplary embodiment, plural sensors 50 are provided in the living room.

Specifically, in the present exemplary embodiment, a temperature sensor 51 that measures a temperature, a humidity sensor 52 that measures a humidity, and an illuminance sensor 53 that measures an illuminance are provided. Further, a human sensor 54 including an infrared sensor and the like is provided to detect a person in the living room.

Each of the sensors 50 transmits acquired information to the image forming apparatus 200 by using wireless communication or wired communication (by performing communication with the image forming apparatus 200). Then, the image forming apparatus 200 transmits information transmitted from the sensors 50 to the management server 10.

In the office environment management system 1, control information used for controlling the controlled devices 30 is transmitted from the management server 10 to the image forming apparatus 200. Then, the image forming apparatus 200 transmits the control information to the corresponding controlled device 30.

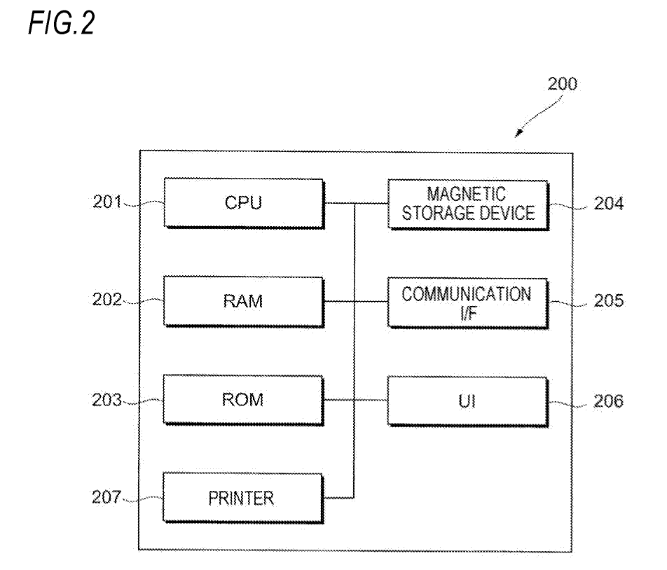

FIG. 2 is a view illustrating a hardware configuration of the image forming apparatus 200.

As illustrated in FIG. 2, the image forming apparatus 200 includes a central processing unit (CPU) 201, a random access memory (RAM) 202, a read only memory (ROM) 203, and a magnetic storage device 204. The image forming apparatus 200 includes a communication interface (communication I/F) 205 used for communicating with the outside.

The image forming apparatus 200 includes a UI 206, and a printer 207.

The UI 206 includes, for example, a touch panel-type display, and displays information of a user and accepts an operation from the user.

The printer 207 as an example of a printing unit performs a printing process (an image forming process) on a sheet as an example of a recording medium by using an electrophotographic system, an inkjet head system or the like.

The ROM 203 and the magnetic storage device 204 store a program to be executed by the CPU 201. The CPU 201 reads a program stored in the ROM 203 or the magnetic storage device 204, and executes the program using the RAM 202 as a work area.

When the program stored in the ROM 203 or the magnetic storage device 204 is executed by the CPU 201, respective functional units to be described below are implemented.

Here, the program executed by the CPU 201 may be provided to the image forming apparatus 200 while being stored in a computer-readable recording medium such as a magnetic recording medium (a magnetic tape, a magnetic disk, or the like), an optical recording medium (an optical disc or the like), a magneto-optical recording medium, or a semiconductor memory. The program executed by the CPU 201 may be downloaded to the image forming apparatus 200 using a communication unit such as the Internet.

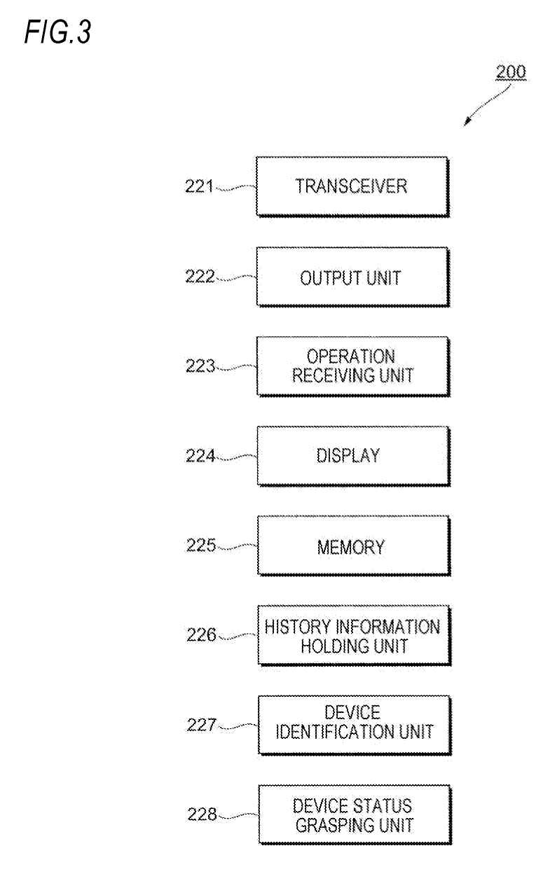

FIG. 3 is a view illustrating respective functional units implemented by the CPU 201 or the like of the image forming apparatus 200.

In the image forming apparatus 200 according to the present exemplary embodiment, as illustrated in FIG. 3, a transceiver 221 is provided. The transceiver 221 is implemented by the CPU 201 that executes a program related to transmission/reception of information, and the communication I/F 205.

The transceiver 221 receives control information from the management server 10, and transmits the control information to the controlled device 30. The transceiver 221 transmits information from the controlled device 30 to the management server 10. The transceiver 221 transmits information from the sensor 50 to the management server 10. The transceiver 221 receives information such as a print job from the computer device 100 (see, e.g., FIG. 1). The transceiver 221 transmits information to the computer device 100.

As illustrated in FIG. 3, the image forming apparatus 200 includes an output unit 222.

The output unit 222 as an example of an output unit is implemented by the CPU 201 that executes a program related to an output processing. The output unit 222 outputs information of the controlled device 30, and the sensor 50. The output unit 222 outputs information of the computer device 100.

Specifically, the output unit 222 displays information of a display 224 (to be described later), prints out information using the printer 207 (see, e.g., FIG. 2), or sends information via e-mail or FAX.

The image forming apparatus 200 includes an operation receiving unit 223, the display 224, a memory 225, a history information holding unit 226, a device identification unit 227, and a device status grasping unit 228.

The operation receiving unit 223 is implemented by the CPU 201 (see, e.g., FIG. 2) that executes a program related to, for example, an operation acceptance, and the UI 206. The operation receiving unit 223 receives information input by the user in the living room.

The display 224 includes the UI 206 (see, e.g., FIG. 2) and displays information to the user in the living room.

The memory 225 includes the magnetic storage device 204 (see, e.g., FIG. 2) or the like, and stores information.

The history information holding unit 226 as an example of a history information holding unit includes the CPU 201, the magnetic storage device 204 and the like, and holds printing history information that is history information of the printing process performed in the image forming apparatus 200. In the printing history information, as described below, information of respective computer devices 100 that have performed printing is included.

The device identification unit 227 as an example of an identification unit is implemented by the CPU 201 that executes a program related to a device identification processing. The device identification unit 227 identifies a status grasping target computer device 100, by information of the computer devices 100, which is included in the printing history information (based on the printing history information).

The device status grasping unit 228 as an example of a device status grasping unit is implemented by the CPU 201 that executes a program for grasping a device status. The device status grasping unit 228 grasps a status of the computer device 100 identified by the device identification unit 227.

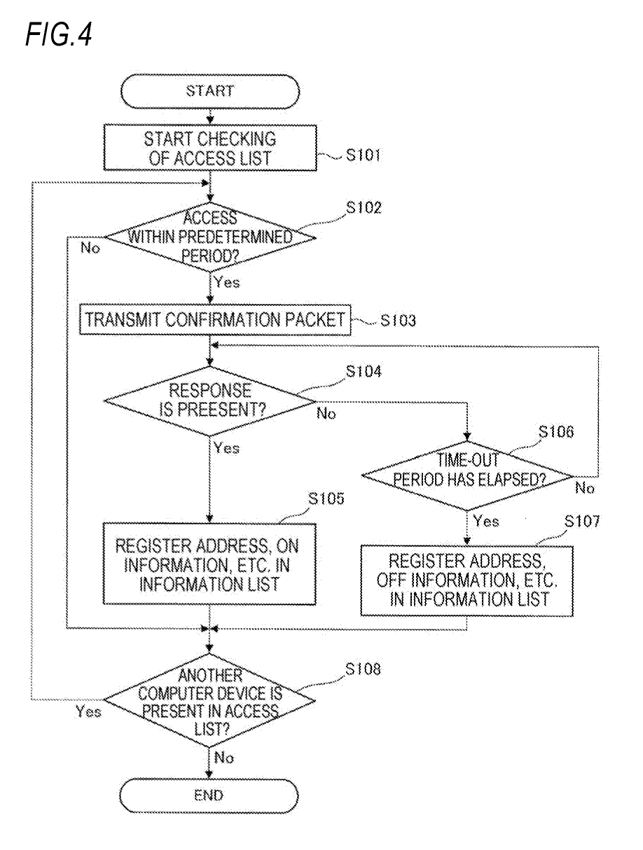

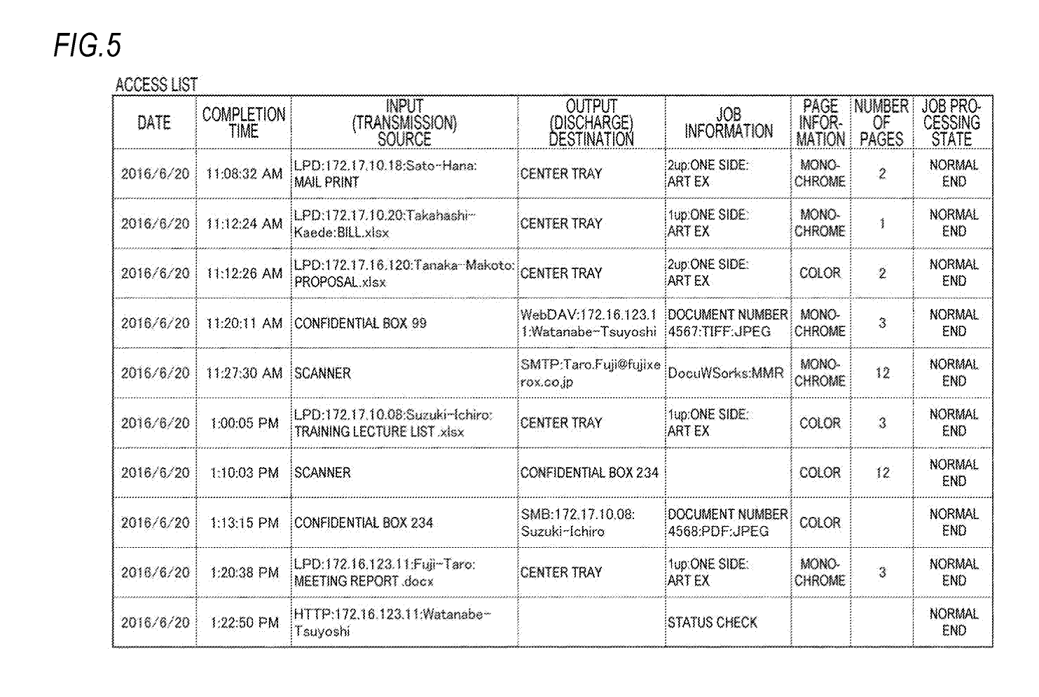

FIG. 4 is a flow chart illustrating a flow of a process executed by the image forming apparatus 200. FIG. 5 is a view illustrating an access list (printing history information) held by the history information holding unit 226.

In the image forming apparatus 200 according to the present exemplary embodiment, first, as indicated by step 101 in FIG. 4, the device identification unit 227 starts checking of the access list (the printing history information) held by the history information holding unit 226, and identifies the status grasping target computer device 100.

FIG. 5 is a view illustrating an access list.

The access list has records of the printing history information that is information of a history of printing performed by the image forming apparatus 200. That is, the access list stores the printing history information including information of each of the computer devices 100 that has performed printing using the image forming apparatus 200.

The access list stores information of the date of access to the image forming apparatus 200, and the access completion time.

The access list stores information of an input source that has input information (job information) to the image forming apparatus 200. Specifically, in this example, an address or the like of the computer device 100 (the computer device 100 that issued a print instruction to the image forming apparatus 200), that has input information to the image forming apparatus 200, is stored as the input source.

As information of the input source, information indicating that the input source is a scanner, information indicating that the input source is a confidential box, or information indicating that the input source is a WEB access is stored.

Here, the confidential box indicates an area provided in the image forming apparatus 200, in which image data input from the scanner or a received fax document is temporarily stored. The WEB access indicates information input to the image forming apparatus 200 via a line such as the Internet.

In the access list, information of an output destination of a result output from the image forming apparatus 200 is stored. Here, in this example, information of a discharge place of a sheet after printing or on a recipient indicating an information transmission destination, or information identifying a confidential box is stored.

In the access list, information of contents of information (job information) input to the image forming apparatus 200, page information indicating whether each page is to be printed in monochrome or color, the number of pages, and a processing status of a job is stored.

Referring back to FIG. 4, a process executed by the image forming apparatus 200 will be further described.

In step 101, as described above, the device identification unit 227 starts checking of an access list stored in the history information holding unit 226. Specifically, the device identification unit 227 starts checking sequentially from a list recorded at the upper side on the access list.

Then, when the input source in the checked list is the computer device 100, the device identification unit 227 determines whether an access to the image forming apparatus 200 by the computer device 100 (an input of job information to the image forming apparatus 200) has been performed within a predetermined period (e.g., within the past two weeks) as indicated by step 102.

Next, when it is determined, in step 102, that the access to the image forming apparatus 200 by the computer device 100 has been performed within the predetermined period, the device identification unit 227 identifies the computer device 100 as a status grasping target computer device 100. When it is determined, in step 102, that the access to the image forming apparatus 200 has not been performed within the predetermined period, the process proceeds to step 108.

Subsequently, in step 103, the device status grasping unit 228 grasps the status of the computer device 100 identified by the device identification unit 227. Specifically, the device status grasping unit 228 transmits a confirmation packet to a network address of the computer device 100.

Next, the device status grasping unit 228 determines whether a response is present from the computer device 100 to which the confirmation packet has been transmitted (step 104).

That is, the device status grasping unit 228 determines the presence or absence of a reply from the computer device 100 to which the confirmation packet has been transmitted.

Next, when it is determined that a response is present from the computer device 100, the device status grasping unit 228 registers an address of the computer device 100, information indicating that the power is in an ON state, user information of the computer device 100, and the like in an information list (to be described later) stored in the memory 225 (see, e.g., FIG. 3) (step 105).

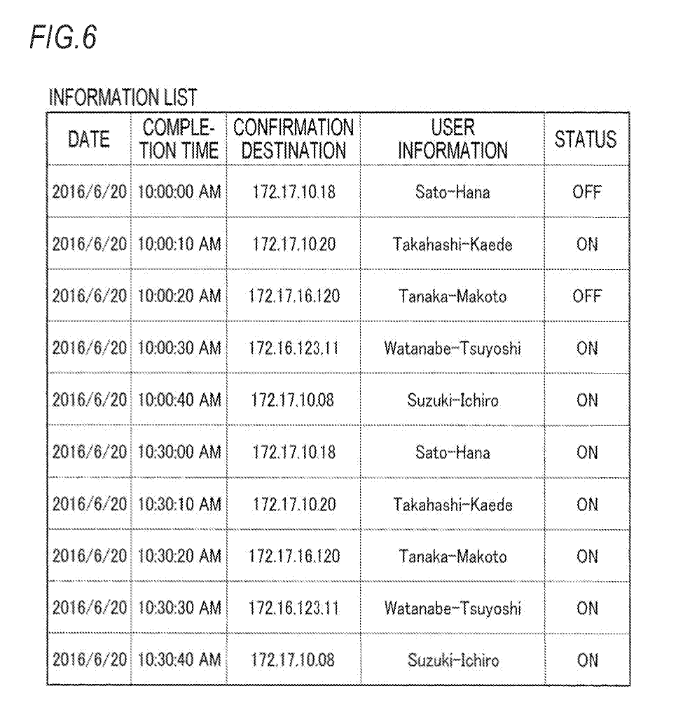

More specifically, in the present exemplary embodiment, the information list (a diagram illustrating the information list) illustrated in FIG. 6 is stored in the memory 225.

In the present exemplary embodiment, when grasping the status of the computer device 100, the device status grasping unit 228 registers a date when the confirmation packet has been transmitted, a time when the confirmation processing has been completed, a confirmation destination (an address of the computer device 100 on which the confirmation processing has been performed), user information of the computer device 100, a status of the computer device 100 (information indicating whether the computer device 100 is in an ON state or an OFF state), in the information list.

Meanwhile, when determination “No” is made in step 104, that is, when it is determined that a response is not present from the computer device 100, the device status grasping unit 228 determines whether a time-out period has elapsed (step 106). When it is determined that the time-out period has not elapsed, the device status grasping unit 228 performs again the processing subsequently to step 104.

Meanwhile, when it is determined that the time-out period has elapsed, the device status grasping unit 228 registers an address of the computer device 100 (which has not issued a response), information indicating that the power is in an OFF state, user information of the computer device 100 and the like, in the information list (step 107).

Thereafter, in the present exemplary embodiment, in step 108, the device identification unit 227 performs again checking of the access list, and determines whether another computer device 100 is present in the access list.

When it is determined that another computer device 100 is present in the access list, the processing subsequently to step 102 are performed again. Meanwhile, when it is determined that no other computer device 100 is present, the process is ended.

In the present exemplary embodiment, as described above, in the image forming apparatus 200, an information list in which a status of each of the computer devices 100 is registered is generated. Then, in the present exemplary embodiment, the generated information list is transmitted to the management server 10 by the transceiver 221 (see, e.g., FIG. 3) of the image forming apparatus 200. Accordingly, the management server 10 may grasp the status of each of the computer devices 100 and the status of a living room.

Here, in the present exemplary embodiment, not only the status of each of the computer devices 100, but also information of the environment where the computer device 100 is provided is obtained. Specifically, in the present exemplary embodiment, not only the status of each of the computer devices 100, but also information of the living room where the computer device 100 is provided is obtained.

More specifically, in the present exemplary embodiment, through the information indicating that each of the computer devices 100 is turned ON or OFF, it is possible to grasp the occupancy status of an employee, or the like in the living room where the computer device 100 is provided.

Here, generally, the image forming apparatus 200 is provided within the living room. The computer device 100 that performs a printing process through the image forming apparatus 200 is provided in the same living room as the living room in which the image forming apparatus 200 is provided.

In this case, when a computer device 100 included in printing history information of the image forming apparatus 200 is identified, and the turning-ON/OFF status of the computer device 100 is grasped, the occupancy status of an employee, or the like in the living room where the image forming apparatus 200 is provided is substantially grasped.

In the above description, a case where confirmation packets are transmitted to all computer devices 100 included in the access list (see, e.g., FIG. 5) has been described as an example. Meanwhile, the confirmation packets may be transmitted to only a part of the computer devices 100 included in the access list, but may not be transmitted to other computer devices 100.

More specifically, in the present exemplary embodiment, a selection request of computer devices 100 to which confirmation packets are not to be transmitted may be accepted from a user through the UI 206 (see, e.g., FIG. 2). The confirmation packets may not be issued to the computer devices 100 on which the selection has been accepted.

The selection of computer devices 100 to which confirmation packets are not to be transmitted may be performed through the UI 206 of the image forming apparatus 200 as described above. Otherwise, devices to be excluded may be accepted through the WEB, and information of the devices accepted through the WEB may be transmitted to the image forming apparatus 200.

Information (information including a network address and the like) on peripheral devices such as the sensors 50, the controlled devices 30 and the like may be registered in advance in the image forming apparatus 200, and then confirmation packets may also be transmitted to the peripheral devices so that the status of each of the peripheral devices may be grasped.

That is, confirmation packets may also be transmitted to devices (other than the computer devices 100) that do not perform printing using the printer 207 (see, e.g., FIG. 2) so that the status of each of the devices may be grasped. In this case, in the same manner as described above, information of other devices may be registered in the information list.

More specifically, in order to grasp the status on each of the peripheral devices such as the sensors 50, the controlled devices 30 and the like, for example, information such as a network address is registered in the image forming apparatus 200 in advance. In this case, information indicating that each of devices is a peripheral device is registered in the image forming apparatus 200 in association with the corresponding peripheral device.

In order to grasp a status, a confirmation packet is transmitted to a device having a type of a peripheral device, and it is determined whether a response has been received.

In the same manner as described above, information indicating “ON” is stored for a device which has issued a response, and information indicating “OFF” is stored for a device which has not issued a response in the information list. When this processing is performed, it may be determined whether the peripheral device is normally operated.

In the same manner as described above, the confirmation packets may be transmitted to only a part of peripheral devices instead of all peripheral devices registered in the image forming apparatus 200, but may not be transmitted to other peripheral devices.

As described above, in the present exemplary embodiment, a selection request of devices to which confirmation packets are not to be transmitted may be accepted from a user through the UI 206 (see, e.g., FIG. 2) or the like. Then, a process of not issuing the confirmation packets to the peripheral devices on which the selection has been accepted may be performed.

Accordingly, it is possible to exclude, for example, some devices which are always powered ON, such as a server, a router, a printer and the like. In this case, packets are not transmitted to the excluded devices, and information of these devices may not be listed on the information list to be output to the management server 10.

In the image forming apparatus 200, when the computer device 100 or the peripheral device is placed in a predetermined status, information of the computer device 100 or the peripheral device placed in the predetermined status may be output.

More specifically, when the computer device 100 or the peripheral device is in an on state, information of the computer device 100 or the peripheral device that is turned ON may be output. Otherwise, when the computer device 100 or the peripheral device is in an off state, information of the computer device 100 or the peripheral device that is turned OFF may be output.

The output of the information is performed by the output unit 222 (see, e.g., FIG. 3) as an example of an output unit. The output unit 222 outputs the information by displaying the information of, for example, the UI 206 (see, e.g., FIG. 2) of the image forming apparatus 200. Otherwise, the output unit 222 issues an alarm sound from the image forming apparatus 200, outputs a printed matter using the printer 207, displays information by transmitting the information to the external device (web display), or sends an e-mail or FAX.

Accordingly, for example, the computer device 100 or the peripheral device, which is powered ON, is notified to a user or an operator. In this case, some devices which are not required but powered ON are powered OFF by the user or the operator. This saves power consumption.

For example, the computer device 100 or the peripheral device, which is powered OFF, is also notified to the user or the operator. In this case, some devices which need to be powered ON but are powered OFF are powered ON by the user or the operator.

Plural image forming apparatuses 200 may be provided within the living room. In this case, the above described information lists may be generated in the respective image forming apparatuses 200, and then the information lists may be combined into one information list by any one of the image forming apparatuses 200, or another apparatus so that the combined information list may be transmitted to the management server 10.

For example, another process may be performed in which software for monitoring whether a user operates each of the computer devices 100 provided in the living room is installed in the corresponding computer device 100, and the image forming apparatus 200 makes an inquiry to each computer device 100.

In this case, in addition to information indicating whether the computer device 100 is turned ON (whether or not an employee or the like is present), operation contents in each computer device 100 may be grasped.

In the above description, the status of each of the computer devices 100 or the peripheral devices is grasped according to the presence/absence of the information sent from the computer devices 100 or the peripheral devices (presence/absence of a response to the confirmation packet). The grasping of the status of each of the computer devices 100 or the peripheral devices is not limited thereto, but may be performed based on the contents of information transmitted from the computer devices 100 or the peripheral devices.

In the above description, in the image forming apparatus 200, retaining of printing history information, identification of a status grasping target computer device 100 or the like, and grasping of a status on the identified computer device 100 are performed. However, these processing may be performed by an information processing apparatus other than the image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a printing unit configured to print on a recording medium using information from terminal devices;
at least one processor configured to execute:
a history information holding unit that holds, in a storage device, printing history information including information of each of the terminal devices that have performed printing using the printing unit; and
an identification unit that identifies status grasping target terminal devices by extracting the information of the terminal devices from the printing history information.

2. The image forming apparatus according to claim 1, wherein the at least one processor is further configured to execute:
a device status grasping unit that grasps a status of each of the terminal devices identified by the identification unit.

3. The image forming apparatus according to claim 2, wherein the device status grasping unit grasps the status of each of the terminal devices using contents of information transmitted from the terminal devices to the image forming apparatus, or presence/absence of information transmitted from the terminal devices to the image forming apparatus.

4. The image forming apparatus according to claim 2, wherein the device status grasping unit further grasps a status of another apparatus that does not perform printing using the printing unit.

5. The image forming apparatus according to claim 3, wherein the device status grasping unit further grasps a status of another apparatus that does not perform printing using the printing unit.

6. The image forming apparatus according to claim 4, wherein the device status grasping unit refrains from grasping a status of a device specified by a user among a plurality of devices included in another apparatus.

7. The image forming apparatus according to claim 5, wherein the device status grasping unit refrains from grasping a status of a device specified by a user among a plurality of devices included in another apparatus.

8. The image forming apparatus according to claim 2, wherein the device status grasping unit grasps a status of each of terminal devices that have performed printing using the printing unit within a predetermined period.

9. The image forming apparatus according to claim 3, wherein the device status grasping unit grasps a status of each of terminal devices that have performed printing using the printing unit within a predetermined period.

10. The image forming apparatus according to claim 4, wherein the device status grasping unit grasps a status of each of terminal devices that have performed printing using the printing unit within a predetermined period.

11. The image forming apparatus according to claim 5, wherein the device status grasping unit grasps a status of each of terminal devices that have performed printing using the printing unit within a predetermined period.

12. The image forming apparatus according to claim 2, wherein the device status grasping unit determines whether each of the terminal devices is placed in a predetermined status, and further comprises an output unit that outputs information of a terminal device placed in the predetermined status.

13. The image forming apparatus according to claim 3, wherein the device status grasping unit determines whether each of the terminal devices is placed in a predetermined status, and further comprises an output unit that outputs information of a terminal device placed in the predetermined status.

14. The image forming apparatus according to claim 4, wherein the device status grasping unit determines whether each of the terminal devices is placed in a predetermined status, and further comprises an output unit that outputs information of a terminal device placed in the predetermined status.

15. The image forming apparatus according to claim 5, wherein the device status grasping unit determines whether each of the terminal devices is placed in a predetermined status, and further comprises an output unit that outputs information of a terminal device placed in the predetermined status.

16. The image forming apparatus according to claim 2, wherein the status of each of the terminal devices includes at least one of an address of the terminal device, information indicating that the terminal device is in an on state, and user information of the terminal device.

17. An information processing apparatus comprising:
at least one processor configured to execute:
a history information holding unit that holds, in a storage device, printing history information including information of each of terminal devices that have performed printing using a printing unit included in an image forming apparatus; and
an identification unit that identifies a status grasping target terminal device by extracting the information of the terminal devices from the printing history information.

18. The information processing apparatus according to claim 17, wherein the at least one processor is further configured to execute:
a device status grasping unit that grasps a status of each of the terminal devices identified by the identification unit.

19. A non-transitory computer readable medium storing a program causing a computer to execute a process for information processing, the process comprising:
holding printing history information including information of each of terminal devices that have performed printing using a printing unit included in an image forming apparatus; and
identifying a status grasping target terminal device by extracting the information of the terminal devices from the printing history information.

20. The image forming apparatus according to claim 1, wherein the at least one processor is configured to generate an information list in which a status of each of the identified status grasping target terminal devices is registered, and
wherein the at least one processor is configured to transmit the generated information list to a management server.
